(19) United States
(12) Patent Application Publication
(10) Pub. No.: US 2016/0078664 A1
(43) Pub. Date: Mar. 17, 2016

(54) IMAGE SYNTHESIZING APPARATUS AND METHOD

(71) Applicant: MITSUBISHI ELECTRIC CORPORATION, Tokyo (JP)

(72) Inventors: Takehisa MIZUGUCHI, Tokyo (JP); Takeshi MITSUI, Tokyo (JP); Hideki FUKUHARA, Tokyo (JP); Yasuaki TAKIMOTO, Tokyo (JP)

(73) Assignee: MITSUBISHI ELECTRIC CORPORATION, Tokyo (JP)

(21) Appl. No.: 14/787,442

(22) PCT Filed: May 17, 2013
(86) PCT No.: PCT/JP2013/063819

§ 371 Date: Oct. 27, 2015

(51) Int. Cl. G06T 13/80; G06T 11/60

(52) U.S. Cl. CPC G06T 13/80; G06T 11/60

(57) ABSTRACT

An image synthesizing apparatus, when synthesizing graphic images a plurality of apparatuses draw, transmits timing request information from the image synthesizing apparatus to the individual drawing apparatuses to fix the timing. Thus, even when graphic images the plurality of apparatuses draw and transmit continuously have a different number of frames, the image synthesizing apparatus can synthesize and display them while synchronizing so far as the timing of changes in an animation.

### TECHNICAL FIELD

The present invention relates to an image synthesizing apparatus and an image synthesizing method that synthesize graphic images a plurality of apparatuses draw to be displayed.

### BACKGROUND ART

Generally, when synthesizing images a plurality of apparatuses draw to be displayed, if the images are still images, simply synthesizing an image an apparatus A draws and an image an apparatus B draws as shown in FIG. 1, for example, enables displaying an image after the synthesis as expected without any problem.

However, if images a plurality of apparatuses draw are graphic images such as an animation, a problem can occur in that unless the synthesis is performed at the right timing, an image (video) after the synthesis does not become as expected, and deviates.

As a technique for synthesizing an image acquired from the outside to be displayed, Patent Documents 1 and 2, for example, describe a synthesizing apparatus that synchronizes the synthesizing timing by considering, when scaling the image received from the outside up or down and synthesizing it with a graphics drawn inside the apparatus (its own apparatus), the time taken for scaling the image acquired from the outside up or down.

### PRIOR ART DOCUMENT

### Patent Document

Patent Document 1: Japanese Patent Laid-Open No. 2004-302361. Patent Document 2: WO2008/139730.

### DISCLOSURE OF THE INVENTION

### Problems to be Solved by the Invention

However, conventional synthesizing apparatuses such as those described in the Patent Documents 1 and 2 do not consider timing difference at the time when synthesizing an image received from the outside with an image drawn inside (its own apparatus) or when synthesizing images received from a plurality of external apparatuses. Accordingly, they have a problem of being unable to synthesize them while synchronizing the timing of changes in animations drawn in the individual apparatuses and transmitted continuously.

The present invention is implemented to solve the foregoing problem. Therefore it is an object of the present invention to provide an image synthesizing apparatus and a method thereof capable of synthesizing graphic images a plurality of apparatuses draw while synchronizing timing of changes in animations transmitted continuously to be displayed.

### Means for Solving the Problem

To accomplish the foregoing object, the present invention comprises, in an image synthesizing apparatus which synthesizes graphic images a plurality of drawing apparatuses draw to be displayed, a controller that controls operation of the image synthesizing apparatus; a timing request information generator that generates timing request information for designating timing for synthesizing the graphic images a plurality of drawing apparatuses draw; a communicator that transmits the timing request information the timing request information generator generates to the plurality of drawing apparatuses; an image input unit that receives the graphic images the plurality of drawing apparatuses draw and transmit; an image synthesizer that receives the instruction from the controller and synthesizes the graphic images the image input unit receives; and a display output unit that causes the graphic image the image synthesizer synthesizes to be displayed, wherein the controller instructs the image synthesizer to synthesize the graphic images when the timing the timing request information designates comes, which timing request information is transmitted to the plurality of the drawing apparatuses via the communicator.

### Advantages of the Invention

According to the present invention, even in the case where the graphic images the plurality of apparatuses draw have difference in the number of frames that are transmitted continuously, the image synthesizing apparatus can synthesize the graphic images to be displayed while synchronizing so far as the timing of the changes in an animation.

### BRIEF DESCRIPTION OF THE DRAWINGS

FIG. 1 is a diagram showing an example of a synthesized image resulting from synthesizing still images a plurality of apparatuses draw;

FIG. 2 is a diagram showing an example of a conventional synthesized image when synthesizing graphic images a plurality of apparatuses draw;

FIG. 3 is a block diagram showing a configuration of an image synthesizing apparatus, a first drawing apparatus and a second drawing apparatus in an embodiment 1;

FIG. 4 is a flowchart showing the operation of the first drawing apparatus (image synthesizing apparatus) and second drawing apparatus in the embodiment 1;

FIG. 5 is a timing chart showing the timing of the operation of the first drawing apparatus (image synthesizing apparatus) and second drawing apparatus in the embodiment 1;

FIG. 6 is a block diagram showing a configuration of an image synthesizing apparatus, a first drawing apparatus and a second drawing apparatus in an embodiment 2;

FIG. 7 is a flowchart showing the operation of the first drawing apparatus (image synthesizing apparatus) and second drawing apparatus in the embodiment 2;

FIG. 8 is a timing chart showing the timing of the operation of the first drawing apparatus (image synthesizing apparatus) and second drawing apparatus in the embodiment 2;

FIG. 9 is a diagram showing an example of a video frame the second drawing apparatus draws in the embodiment 2;

FIG. 10 is a diagram showing another example of a video frame the second drawing apparatus draws in the embodiment 2;

FIG. 11 is a block diagram showing a configuration of an image synthesizing apparatus, a first drawing apparatus and a second drawing apparatus in an embodiment 3;

FIG. 12 is a flowchart showing the operation of the first drawing apparatus (image synthesizing apparatus) and second drawing apparatus in the embodiment 3;

FIG. 13 is a timing chart showing the timing of the operation of the first drawing apparatus (image synthesizing apparatus) and second drawing apparatus in the embodiment 3;

FIG. 14 is a block diagram showing a configuration of an image synthesizing apparatus, a first drawing apparatus and a second drawing apparatus in an embodiment 4;

FIG. 15 is a flowchart showing the operation of the image synthesizing apparatus, first drawing apparatus and second drawing apparatus in the embodiment 4;

FIG. 16 is a timing chart showing the timing of the operation of the image synthesizing apparatus, first drawing apparatus and second drawing apparatus in the embodiment 4; and

FIG. 17 is a diagram showing an outline of an image synthesizing system in an embodiment 5.

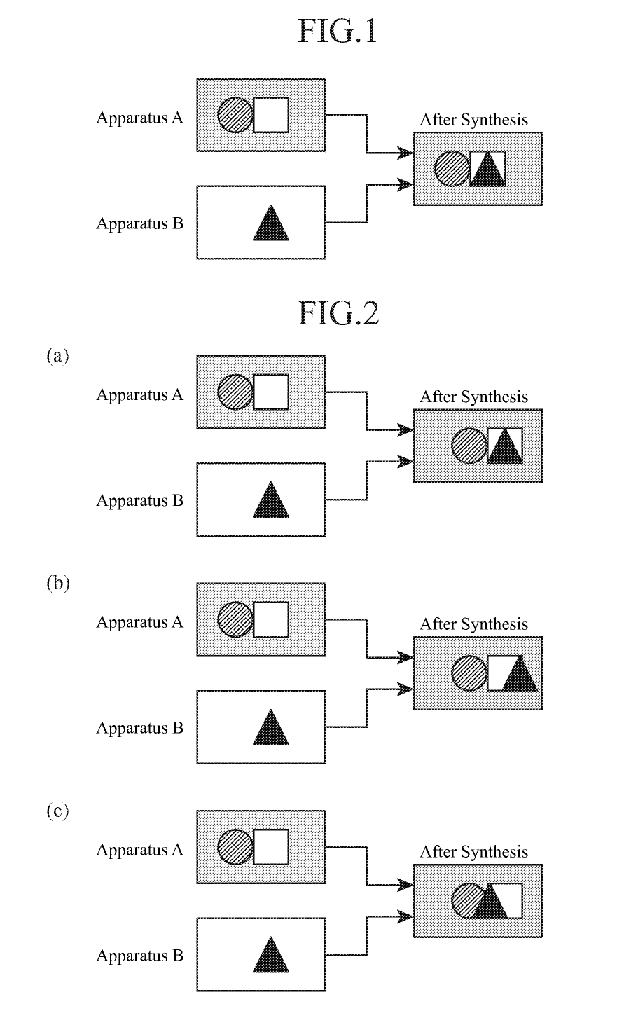

### BEST MODE FOR CARRYING OUT THE INVENTION

The best mode for carrying out the invention will now be described with reference to the accompanying drawings.

### Embodiment 1

FIG. 2 is a diagram showing an example of a conventional synthesized image when synthesizing graphic images a plurality of apparatuses draw. For example, to obtain the synthesized image as shown in FIG. 2(a) from a graphic image an apparatus A draws and a graphic image an apparatus B draws, the conventional apparatuses cannot synchronize so far as to the timing of changes in animations transmitted continuously from the apparatuses A and B. Thus, as shown in FIG. 2 (b) and FIG. 2 (c), images shifting from the right timing of synthesis can sometimes result.

In view of this, according to the present invention, as for an image synthesizing apparatus that synthesizes graphic images a plurality of drawing apparatuses draw to be displayed, it provides an image synthesizing apparatus and method capable of acquiring the graphic images with their timing being matched from the individual drawing apparatuses by transmitting timing request information from the image synthesizing apparatus to the drawing apparatuses that draw the graphic images before the synthesis, and capable of synthesizing them.

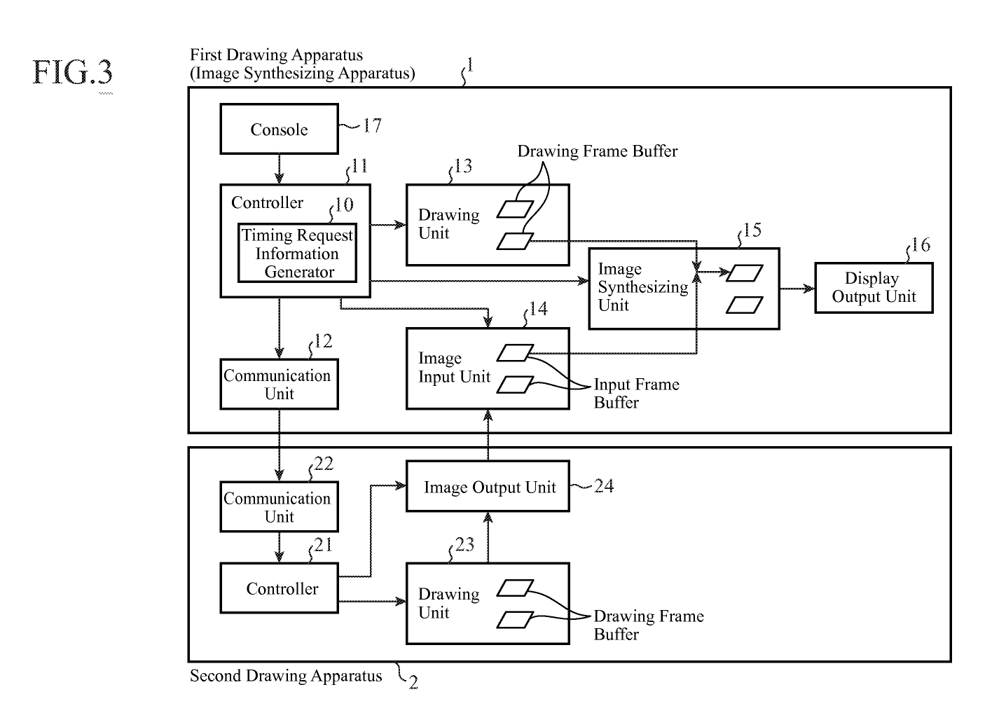

FIG. 3 is a block diagram showing a configuration of an image synthesizing apparatus, a first drawing apparatus, and a second drawing apparatus of an embodiment 1 in accordance with the present invention. Incidentally, it is assumed in the present embodiment 1 that first drawing apparatus=image synthesizing apparatus.

The first drawing apparatus (image synthesizing apparatus) 1 comprises a controller 11, a communication unit 12, a drawing unit 13, an image input unit 14, an image synthesizing unit 15, a display output unit (display unit) 16, and a console 17.

The controller 11, which controls the operation of the first drawing apparatus (image synthesizing apparatus) 1, controls drawing of a video frame by the first drawing apparatus (image synthesizing apparatus) 1, and synthesis of a video frame received from the second drawing apparatus 2 and the video frame of the first drawing apparatus (image synthesizing apparatus) 1, and the like.

In addition, the controller 11 comprises a timing request information generator 10.

The timing request information generator 10 generates in the controller 11 the timing request information for designating the timing for synthesizing graphic images a plurality of drawing apparatuses draw. More specifically, it generates the timing request information that indicates the timing for the second drawing apparatus 2 to draw a picture and the timing for switching a frame buffer.

The communication unit 12 exchanges an operational instruction and a response thereto with the second drawing apparatus 2. Thus, it transmits at least the timing request information the timing request information generator 10 generates to the second drawing apparatus 2. As a practical method for implementing it, there are serial communication, USB, wireless LAN, Bluetooth (registered trademark) and the like, for example.

The drawing unit 13 draws a graphic image to be displayed on a screen. The drawing unit 13 manages a plurality of (two in FIG. 3) frame buffers, and draws a graphic image in the frame buffers (memory).

The image input unit 14 periodically receives a video frame (a graphic image the second drawing apparatus 2 draws and transmits) from the second drawing apparatus 2. As a method of receiving a video frame, there are an HDMI (High-Definition Multimedia Interface: registered trademark, the mention of which will be omitted below), DVI (Digital Video Interactive), composite, RGB and the like, for example. They have a plurality of frame buffers (memory) for receiving a video frame, and records the video frame it receives.

The image synthesizing unit 15 receives an instruction from the controller 11, and synthesizes the graphic image the drawing unit 13 draws and a video frame (graphic image) the image input unit 14 receives.

The display output unit 16 outputs the video frame (graphic image) the image synthesizing unit 15 synthesizes to a display or the like to be displayed.

The console 17 receives an operation of a user.

The second drawing apparatus 2 comprises a controller 21, a communication unit 22, a drawing unit 23, and an image output unit 24.

The controller 21, which controls the operation of the second drawing apparatus 2, controls a graphic image drawing by the second drawing apparatus 2, and transmission of the video frame from the second drawing apparatus 2 to the first drawing apparatus (image synthesizing apparatus) 1.

The communication unit 22 exchanges an operational instruction and the response to it with the first drawing apparatus (image synthesizing apparatus) 1.

The drawing unit 23 draws a graphic image to be displayed on the screen.

The image output unit 24 periodically transmits a video frame from the second drawing apparatus 2. As a receiving method of an image, there are HDMI, composite and the like, for example.

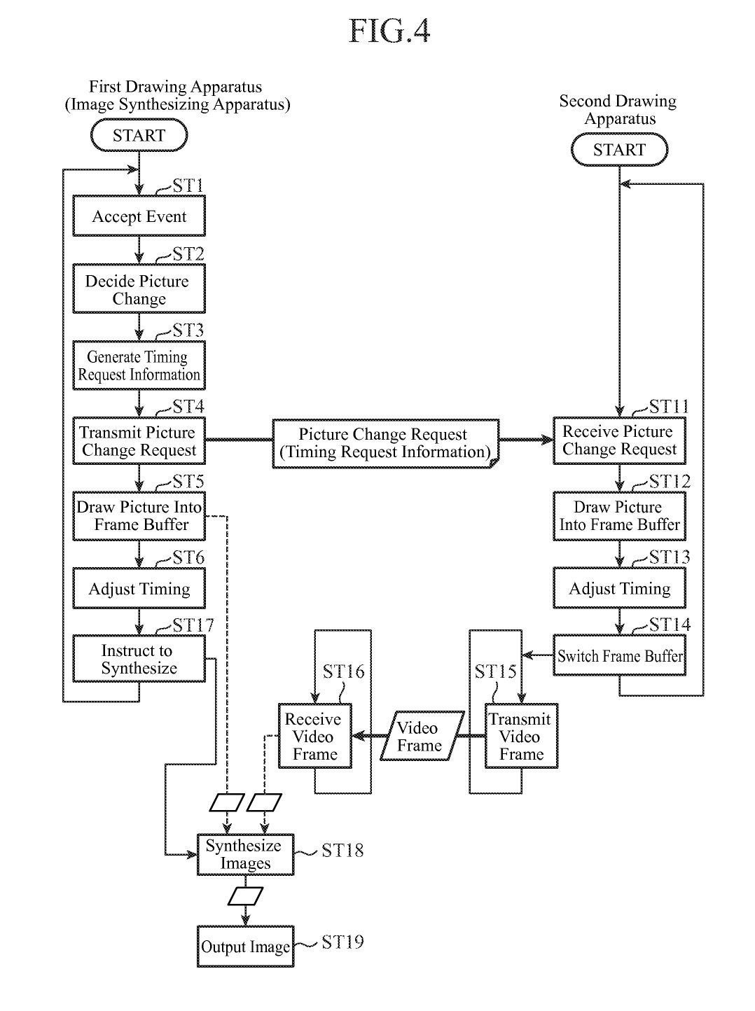

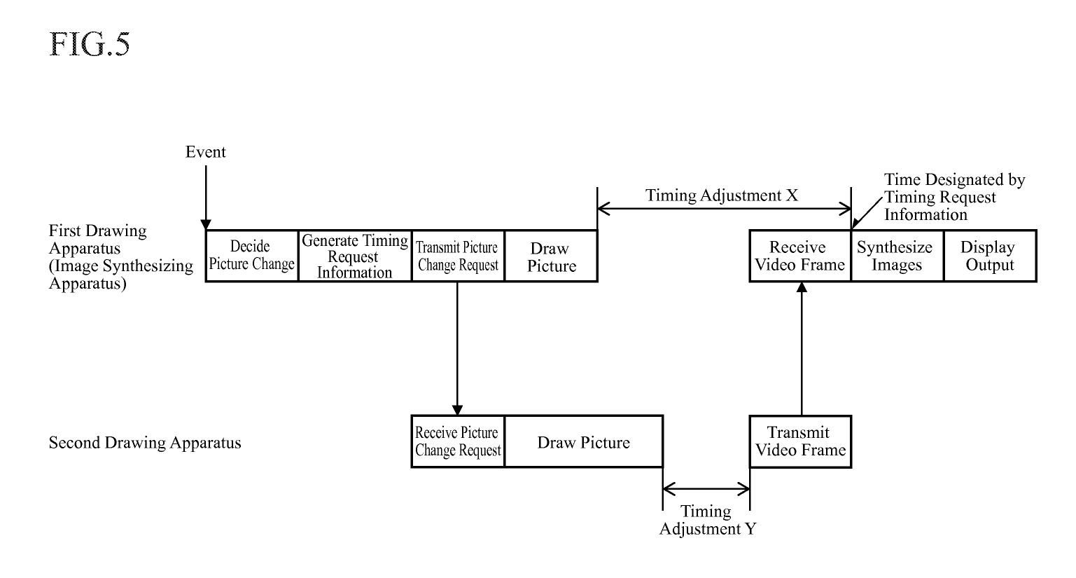

Next, the operation will be described with reference to FIG. 4 and FIG. 5.

FIG. 4 is a flowchart showing the operation of the first drawing apparatus (image synthesizing apparatus) and second drawing apparatus in the embodiment 1.

In addition, FIG. 5 is a timing chart showing the timing of the operation of the first drawing apparatus (image synthesizing apparatus) and second drawing apparatus in the embodiment 1.

First, the controller 11 of the first drawing apparatus (image synthesizing apparatus) 1 receives a user operation event from the console 17 (step ST1). Next, it decides a picture change from the event received (step ST2), and generates the timing request information for making the picture change (step ST3).

The timing request information is information that designates the time for carrying out picture synthesis which will be described later by considering the drawing time by the first drawing apparatus (image synthesizing apparatus) 1 and the second drawing apparatus 2, and the video frame transmission time.

This is because the time taken by the first drawing apparatus (image synthesizing apparatus) 1 to draw a picture differs in general from the time taken by the second drawing apparatus 2 to draw a picture and to transmit the picture image to the first drawing apparatus (image synthesizing apparatus) 1.

More specifically, the timing request information has a purpose for the first drawing apparatus (image synthesizing apparatus) 1 to transmit the information it generates about what timing it wants the second drawing apparatus 2 to make a drawing. For example, the timing request information can be any information that is able to designate the timing specifically such as time, elapsed time from the communication starting time by the communication unit 12, a video frame number and the like.

Next, the controller 11 of the first drawing apparatus (image synthesizing apparatus) 1 transmits a picture change request containing the timing request information it generates at step ST3 to the controller 21 of the second drawing apparatus 2 via the communication units 12 and 22 (step ST4).

Next, the controller 11 of the first drawing apparatus (image synthesizing apparatus) 1 causes the drawing unit 13 to draw a picture on a drawing frame buffer (step ST5). Here, a plurality of drawing frame buffers are prepared for the controller 11 to draw on one of them. This is a technique generally referred to as double buffering or triple buffering which separately prepares a frame buffer on which the drawing has been completed and a frame buffer on which the drawing is being made so as to carry out the image output for display in parallel with the drawing processing.

After that, the first drawing apparatus (image synthesizing apparatus) 1 waits until the timing which is designated by the timing request information it generates at step ST3 (the time in the present embodiment 1) comes, and carries out a timing adjustment (see “timing adjustment X” shown in FIG. 5) (step ST6). More specifically, when the timing request information designates the timing in terms of the time, the first drawing apparatus 1 delays the image synthesis instruction until the time indicated by the timing request information.

The second drawing apparatus 2, receiving the picture change request from the first drawing apparatus (image synthesizing apparatus) 1 (step ST11), causes the drawing unit 23 to draw a picture on the drawing frame buffer (step ST12).

Incidentally, the picture change request received from the first drawing apparatus (image synthesizing apparatus) 1 at step ST11 contains the timing request information the first drawing apparatus (image synthesizing apparatus) 1 generates at step ST3.

After that, the second drawing apparatus 2 waits until the time comes which is obtained by subtracting the time taken for transmitting the video frame from the time designated by the timing request information, carries out the timing adjustment (see “timing adjustment Y” shown in FIG. 5) (step ST13), and then switches the drawing frame buffer to be output from the image output unit 24 (step ST14).

The image output unit 24 periodically transmits the video frame from the drawing frame buffer to the image input unit 14 of the first drawing apparatus (image synthesizing apparatus) 1 (step ST15).

Here, the image input unit 14 of the first drawing apparatus (image synthesizing apparatus) 1 receives the video frame from the image output unit 24 of the second drawing apparatus 2 (step ST16), and stores the video frame received into an input frame buffer of the image input unit 14.

Then, when the timing (time) designated by the timing request information comes, that is, the timing designated by the timing request information transmitted to the second drawing apparatus 2 via the communication unit 12 comes, the controller 11 of the first drawing apparatus (image synthesizing apparatus) 1 instructs the image synthesizing unit 15 to synthesize the graphic images (step ST17).

The image synthesizing unit 15 synthesizes the drawing frame buffer newly drawn by the drawing unit 13 and the input frame buffer received from the second drawing apparatus 2 by the image input unit 14 (step ST18). The image synthesized is output to a display by the display output unit 16 to be displayed (step ST19).

As described above, according to the present embodiment 1, the first drawing apparatus (image synthesizing apparatus) transmits to the second drawing apparatus the timing request information together with the picture change request, and both the first drawing apparatus (image synthesizing apparatus) and the second drawing apparatus synchronize the timing for switching the target frame buffers to be synthesized. Thus, it can synthesize the graphic images the plurality of apparatuses draw with their timing being matched to be displayed.

As a result, even if the graphic images the plurality of apparatuses draw differ in the number of frames continuously transmitted, the present embodiment 1 can synthesizes them while synchronizing them so far as to the timing of changes in the animations to be displayed.

Incidentally, although the present embodiment 1 is described by way of example in which the timing request information designates the time for starting the image synthesis, it can also designate and instruct the video frame number the image input unit or image output unit transmits periodically.

In addition, as described before, as for the timing request information, it is not limited to the time. For example, it can be any other method which enables the first drawing apparatus (image synthesizing apparatus) and the second drawing apparatus to share the timing such as a frame number of the video transmission between the first drawing apparatus (image synthesizing apparatus) and the second drawing apparatus, the elapsed time from the communication start by the communication units and the like.

Incidentally, although the present embodiment 1 is described by way of example that receives an event caused by the user operation to change a picture, a trigger of the picture change can be a state alteration event received from other equipment, or other event such as a timer.

### Embodiment 2

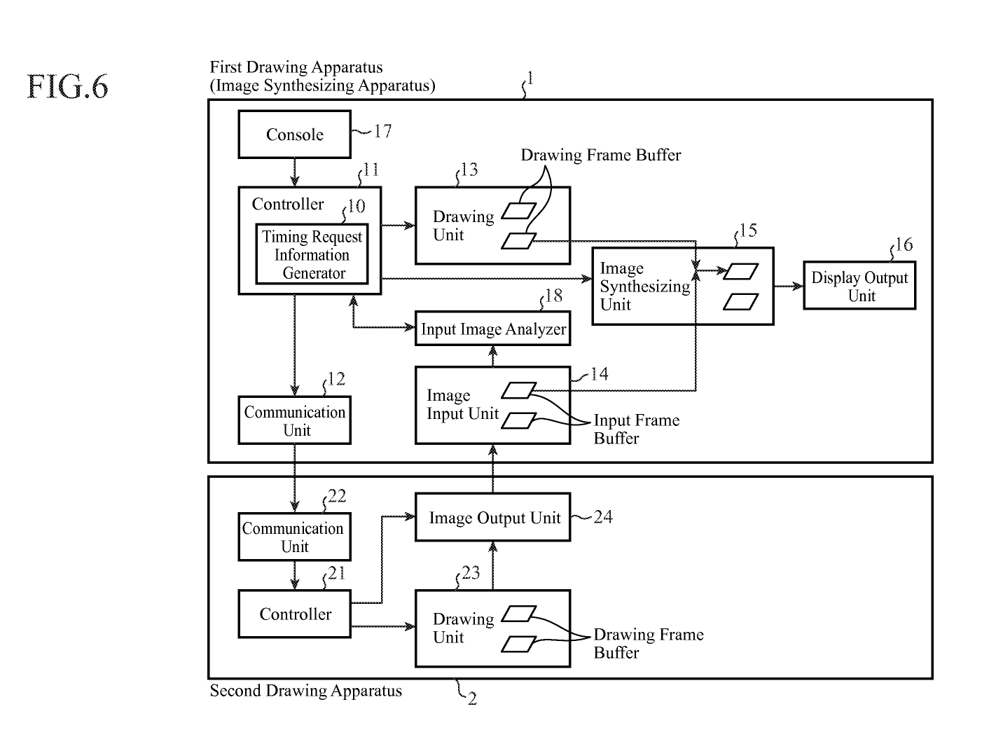

FIG. 6 is a block diagram showing a configuration of an image synthesizing apparatus, a first drawing apparatus, and a second drawing apparatus of an embodiment 2 in accordance with the present invention. In addition, it is also assumed in the present embodiment 2 that the first drawing apparatus=image synthesizing apparatus as in the embodiment 1. Incidentally, the same components as those described in the embodiment 1 are designated by the same reference symbols and their duplicate description will be omitted.

The embodiment 2 described below differs from the embodiment 1 in that the first drawing apparatus (image synthesizing apparatus) 1 further comprises an input image analyzer 18, and that it carries out synthesis in synchronization with the timing at which the second drawing apparatus 2 side completes the drawing.

The input image analyzer 18 analyzes a video frame (graphic image) the image input unit 14 receives from the second drawing apparatus 2, and extracts the timing information designating the timing the video frame was drawn.

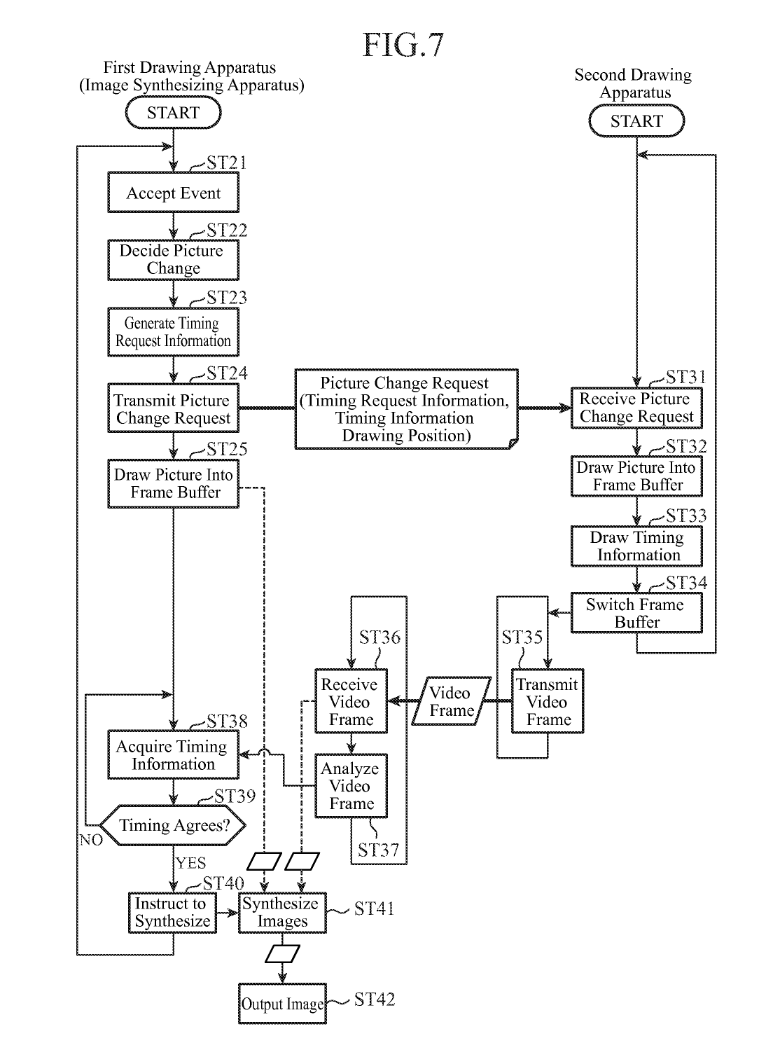

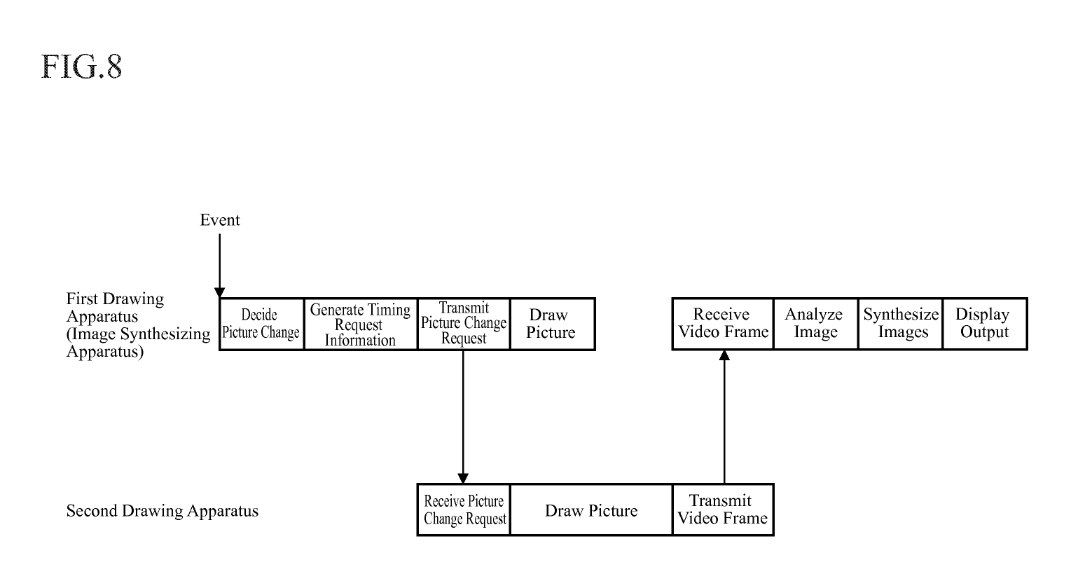

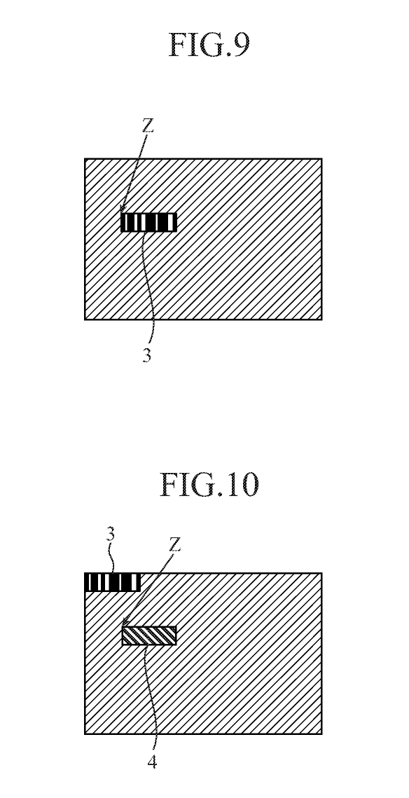

The operation of the present embodiment 2 will now be described with reference to FIG. 7 and FIG. 8.

FIG. 7 is a flowchart showing the operation of the first drawing apparatus (image synthesizing apparatus) and second drawing apparatus in the embodiment 2.

In addition, FIG. 8 is a timing chart showing the timing of the operation of the first drawing apparatus (image synthesizing apparatus) and second drawing apparatus in the embodiment 2.

As for the processing at steps ST21-ST22, since it is the same as that at steps ST1-ST2 in FIG. 4 of the embodiment 1, their description will be omitted.

In addition, as for the processing for generating the timing request information for making a picture change (step ST23), it is the same as that at step ST3.

It is assumed in the description of the present embodiment 2, however, that the timing request information is not for designating the time for carrying out the picture synthesis as in the embodiment 1, but a video frame number. In this case, the controller 11 can generate the timing request information by identifying the video frame number that requests the picture change as a result of deciding the picture change at step ST22.

Then, the controller 11 of the first drawing apparatus (image synthesizing apparatus) 1 transmits a picture change request that contains not only the timing request information it generates at step ST23, but also a timing information drawing position (details of which will be described later. See FIG. 9 and FIG. 10) that designates a position at which the second drawing apparatus 2 draws the timing information on the video frame to the controller 21 of the second drawing apparatus 2 via the communication units 12 and 22 (step ST24).

The position at which the timing information is to be drawn is selected from an area not used for image synthesis in the video frame on which the second drawing apparatus 2 draws.

Next, the controller 11 of the first drawing apparatus (image synthesizing apparatus) 1 causes the drawing unit 13 to draw a picture on a drawing frame buffer (step ST25).

After that, the first drawing apparatus (image synthesizing apparatus) 1 waits until it receives the video frame with the timing information corresponding to the timing request information from the second drawing apparatus 2 (details of which will be described later).

The second drawing apparatus 2, when receiving a picture change request from the first drawing apparatus (image synthesizing apparatus) 1 (step ST31), it draws a picture on a drawing frame buffer by the drawing unit 23 (step ST32).

Furthermore, it draws the timing information at the timing information drawing position on the drawing frame buffer (step ST33).

As a method of drawing the timing information, the following methods are conceivable.

(1) Draw as the timing information a two-dimensional code such as a bar code and QR code (registered trademark), which will facilitate image analysis (see FIG. 9 and FIG. 10). It is suitable for transmitting an image in an analog format such as a composite system.

(2) Draw the timing information in characters or letters (character string). Since a person can read it, it will facilitate debugging.

(3) Draw as the timing information a drawing ID (binary value) converted into a bitmap image. It is suitable for transmitting a video frame in digital data such as HDMI, and it does not require any special conversion.

(4) Impress as the timing information an invisible digital watermark in a video frame. In this case, it can display the whole video frame of the second drawing apparatus 2 without losing a part of the video frame of the second drawing apparatus 2 as shown in FIG. 9 or FIG. 10. In addition, it is not necessary in this case to transfer the timing information drawing position, and can enable drawing the timing information at a fixed position such as at the upper right or upper left.

After that, the second drawing apparatus 2 switches the drawing frame buffer to be output by the image output unit 24 (step ST34).

The image output unit 24 periodically transmits the video frame from the drawing frame buffer to the image input unit 14 of the first drawing apparatus (image synthesizing apparatus) 1 (step ST35).

Here, the image input unit 14 of the first drawing apparatus (image synthesizing apparatus) 1 receives the video frame from the image output unit 24 of the second drawing apparatus 2 (step ST36), and stores the received video frame in an input frame buffer of the image input unit 14.

Next, the input image analyzer 18 of the first drawing apparatus (image synthesizing apparatus) 1 analyzes the video frame (graphic image) the image input unit 14 receives from the second drawing apparatus 2, and acquires the timing information drawn at the timing information drawing position it transmits via the communication unit 12 (step ST37).

In other words, the position in the video frame to be analyzed is the timing information drawing position the first drawing apparatus (image synthesizing apparatus) 1 transmits to the second drawing apparatus 2. Then, the input image analyzer 18 delivers the timing information obtained by the analysis to the controller 11.

The controller 11 acquires the timing information from the input image analyzer 18 (step ST38), and compares the timing information it acquires with the timing request information it transmits to the second drawing apparatus 2 at step ST24 to decide whether they agree with each other (step ST39).

Then, when the timing information it acquires agrees with the timing request information, that is, when the timing information it acquires becomes equal to the timing designated by the timing request information (YES at step ST39), the controller 11 instructs the image synthesizing unit 15 to synthesize the graphic images (step ST40). On the other hand, when they disagree, that is, unless they are the same timing (NO at step ST39), the controller 11 waits until it receives the video frame containing the timing information matching the timing of the timing request information.

After that, the image synthesizing unit 15 synthesizes the drawing frame buffer the drawing unit 13 newly draws with the input frame buffer the image input unit 14 receives from the second drawing apparatus 2 (step ST41). The image synthesized is output to the display or the like by the display output unit 16 to be displayed (step ST42).

To be concrete, for example, the present embodiment 2 is effective in such a case where the drawing rates differ such as the drawing rate of the first drawing apparatus (image synthesizing apparatus) 1 is 60 frames per second and that of the second drawing apparatus 2 is 30 frames per second. For example, consider the case where the frame number designated by the timing request information is 10. In this case, even if the first drawing apparatus (image synthesizing apparatus) 1 has already drawn the video frame of the frame number 10, if the timing information of the video frame it acquires from the second drawing apparatus 2 indicates the frame number 8, it does not issue a synthesis instruction, but waits until it acquires the video frame with the timing information of frame number 10 and then carries out the image synthesis to be displayed.

FIG. 9 is a diagram showing an example of a video frame the second drawing apparatus in the embodiment 2 draws.

FIG. 9 show a state in which the timing information 3 is drawn at the timing information drawing position Z the first drawing apparatus (image synthesizing apparatus) 1 designates.

In addition, FIG. 10 is a diagram showing another example of the video frame the second drawing apparatus in the embodiment 2 draws.

In the example shown in FIG. 9, although the timing information 3 is drawn at the timing information drawing position Z, it is also possible to draw the timing information 3 at the fixed position (at the upper left, for example) in the video frame, and to draw an image 4 to be drawn in the fixed position at the timing information drawing position Z instead.

Here, the timing information 3 is drawn at the upper left in the video frame, and the image 4 which is to be placed at the upper left in the original video frame is drawn at the timing information drawing position Z.

In this case, the video frame analysis processing can always perform the timing information analysis at the fixed position (at the upper left in FIG. 10). In addition, after the analysis processing, copying the image area at the timing information drawing position onto the position of the timing information makes it possible to execute the processing (image synthesis) thereafter.

As described above, according to the present embodiment 2, the first drawing apparatus (image synthesizing apparatus) transmits to the second drawing apparatus the timing request information and the timing information drawing position together with the picture change request; the second drawing apparatus draws the timing information in the video frame to be transmitted to the first drawing apparatus (image synthesizing apparatus); and the first drawing apparatus (image synthesizing apparatus) analyzes it, and if it decides that it receives the video frame corresponding to the request from the first drawing apparatus (image synthesizing apparatus), it synthesizes the images at the timing. The configuration enables synthesizing the graphic images the first drawing apparatus (image synthesizing apparatus) and the second drawing apparatus draw, respectively, while synchronizing the timing, and enables display.

In addition, since the instant method draws the timing information on the video frame sent from the second drawing apparatus side to the first drawing apparatus (image synthesizing apparatus) side, it is characterized by that it does not require any particular communication path for transmitting the timing information in synchronization with the timing of the video frame transmission. In addition, since it sends the information along with the image, it can transmit the timing accurately.

It is also possible, for example, to install the controller of the second drawing apparatus as a common application of a PC, smartphone or the like.

### Embodiment 3

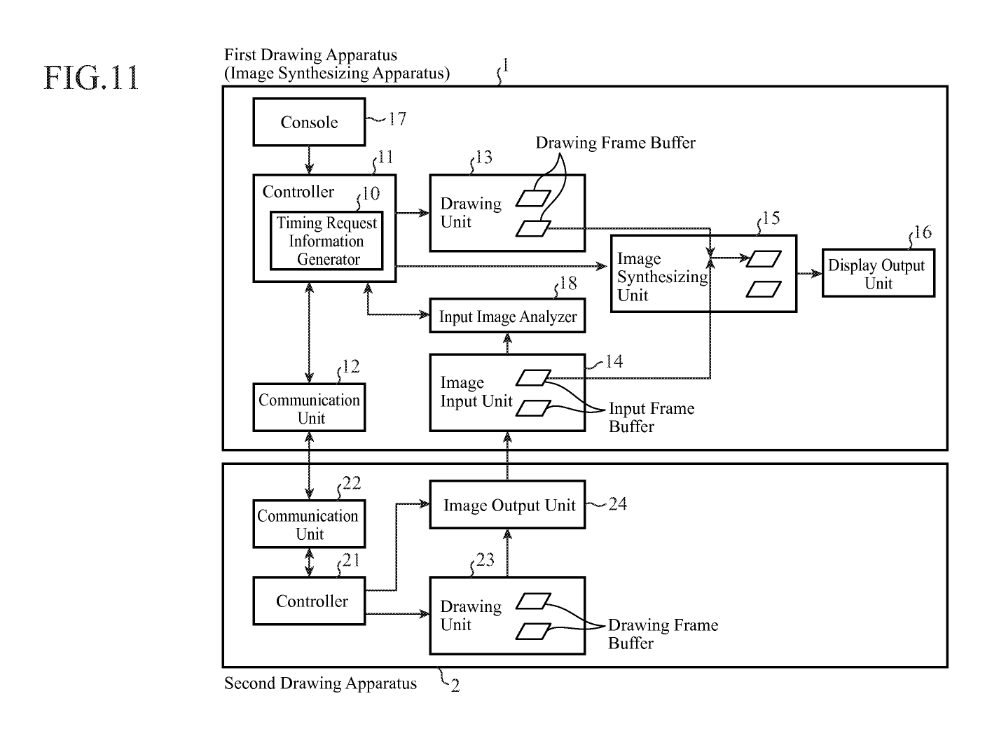

FIG. 11 is a block diagram showing a configuration of the image synthesizing apparatus, the first drawing apparatus, and the second drawing apparatus of an embodiment 3 in accordance with the present invention 3. It is also assumed in the present embodiment 3 that the first drawing apparatus=the image synthesizing apparatus as in the embodiments 1 and 2. Incidentally, the same components as those described in the embodiments 1 and 2 are designated by the same reference symbols and their description will be omitted. In addition, as for the processing, the same portions as those of the embodiment 2 will be omitted from the drawing and description, and only the portion different from the embodiment 2 will be described.

As for the timing information drawing position, although the first drawing apparatus (image synthesizing apparatus) 1 transmits it to the second drawing apparatus 2 in the embodiment 2, the present embodiment 3 is configured in such a manner that the second drawing apparatus 2 side determines it and transmits to the first drawing apparatus (image synthesizing apparatus) 1.

Although the block diagram (system configuration diagram) shown in FIG. 11 is nearly the same as the block diagram (system configuration diagram) shown in FIG. 6 of the embodiment 2, it differs in that the communication direction of the controller 11 and communication unit 12 of the first drawing apparatus (image synthesizing apparatus) 1 and the controller 21 and communication unit 22 of the second drawing apparatus 2 is bidirectional.

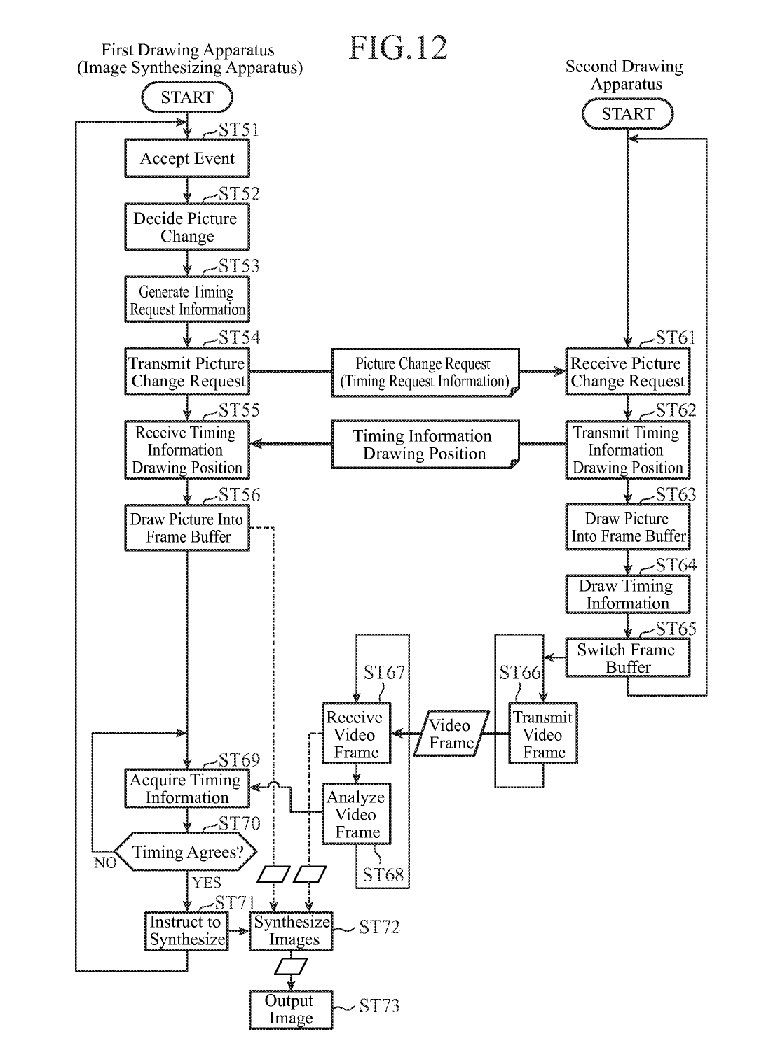

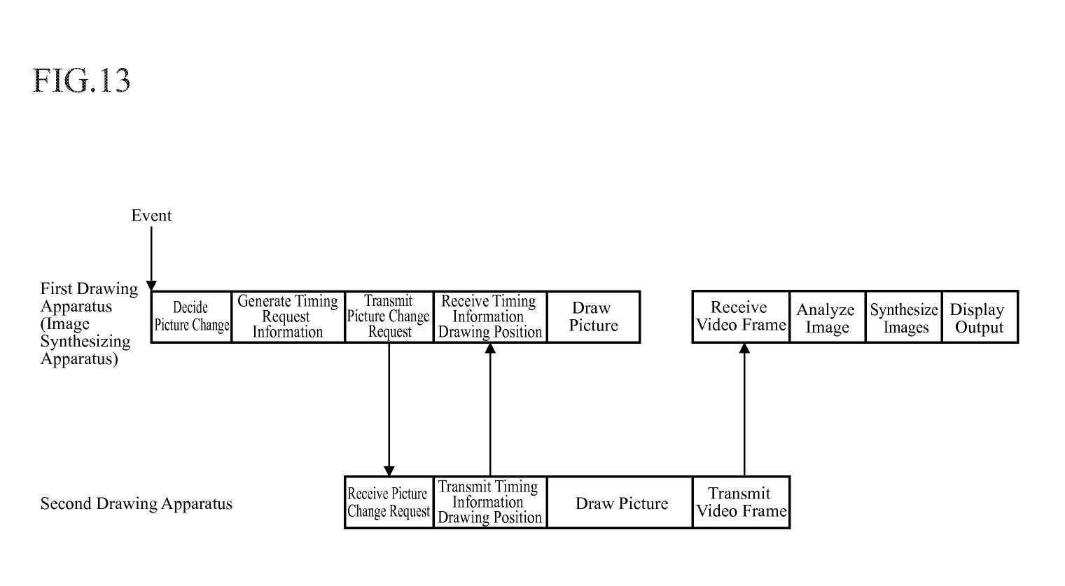

The operation of the present embodiment 3 will be described with reference to FIG. 12 and FIG. 13.

FIG. 12 is a flowchart showing the operation of the first drawing apparatus (image synthesizing apparatus) and second drawing apparatus of the embodiment 3.

In addition, FIG. 13 is a timing chart showing the timing of the operation of the first drawing apparatus (image synthesizing apparatus) and second drawing apparatus of the embodiment 3.

The difference in the operation between the embodiment 3 and embodiment 2 is only that the timing information drawing position is not contained in the picture change request which is transmitted from the first drawing apparatus (image synthesizing apparatus) 1 to the second drawing apparatus 2 at step ST54, but is transmitted from the second drawing apparatus 2 to the first drawing apparatus (image synthesizing apparatus) 1.

More specifically, although steps ST51-ST54 and ST61 are the same as steps ST21-ST24 and ST31 in FIG. 7 of the embodiment 2, the second drawing apparatus 2, receiving the picture change request, determines the timing information drawing position and transmits it to the first drawing apparatus (image synthesizing apparatus) 1 (step ST62).

The reason for this is that since the second drawing apparatus 2 side knows the position not used for an image, it sends to the first drawing apparatus (image synthesizing apparatus) the information that it draws the timing information at the position and transmits it.

The first drawing apparatus (image synthesizing apparatus) 1, receiving the timing information drawing position from the second drawing apparatus 2 (step ST55), compares the information drawn at the position with the timing request information it generates at step ST53 when comparing the timing information (see step ST70).

Incidentally, as for step ST56 and steps ST63-ST73, since they differ from step ST25 and steps ST32-ST42 in FIG. 7 of the embodiment 2 only in that when comparing the timing information at step ST70, the position at which the timing information is drawn differs from that of the embodiment 2 as described above, description of the other operations will be omitted.

The present embodiment 3 can achieve the same advantages as those of the embodiment 2.

### Embodiment 4

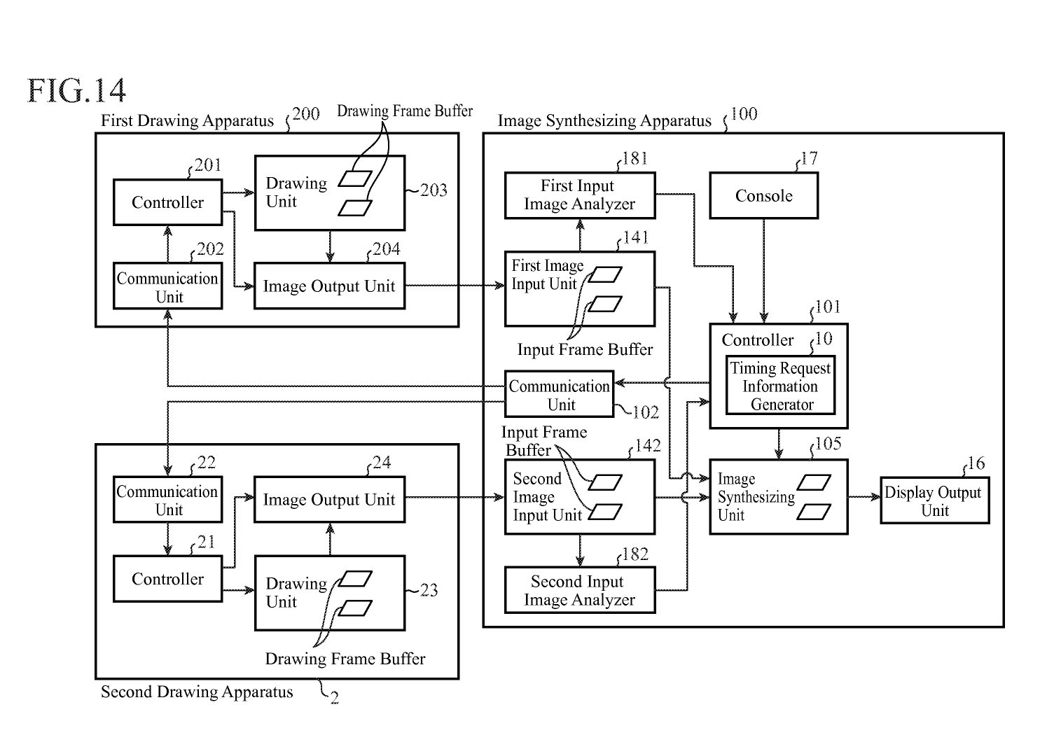

FIG. 14 is a block diagram showing a configuration of the image synthesizing apparatus, first drawing apparatus, and second drawing apparatus of an embodiment 4 in accordance with the present invention. Incidentally, the same components as those described in the embodiments 1-3 are designated by the same reference symbols and their duplicate description will be omitted.

Although the embodiments 1-3 are all described on the assumption that the first drawing apparatus=image synthesizing apparatus, the present embodiment 4 has a configuration in which drawing of two pictures and image synthesis are carried out by separate apparatuses each. More specifically, the present embodiment 4 is applicable to a server which is connected to two drawing apparatuses and is used as an image synthesizing apparatus, for example.

Incidentally, although the present embodiment 4 will be described using an example in which the first drawing apparatus (image synthesizing apparatus) 1 of the embodiment 2 is divided into two separate apparatuses, a first drawing apparatus 200 and an image synthesizing apparatus 100, it goes without saying that as for the configuration corresponding to the embodiment 1 or 3, the first drawing apparatus (image synthesizing apparatus) 1 can be divided into the separate apparatuses, the first drawing apparatus 200 and image synthesizing apparatus 100.

The second drawing apparatus 2 is the same as the second drawing apparatus 2 in the embodiments 1-3. In addition, the first drawing apparatus 200 has the same configuration as the second drawing apparatus 2.

The image synthesizing apparatus 100 differs from the first drawing apparatus (image synthesizing apparatus) 1 of the embodiment 2 in that the drawing unit 13 is removed and that the image input unit and input image analyzer are added thereto with respect to each of the first drawing apparatus 200 and second drawing apparatus 2.

More specifically, the image synthesizing apparatus 100 of the present embodiment 4 comprises a controller 101, a communication unit 102, a first image input unit 141, a second image input unit 142, an image synthesizing unit 105, the display output unit (display unit) 16, the console 17, a first input image analyzer 181, and a second input image analyzer 182.

The controller 101, which controls the operation of the image synthesizing apparatus 100, controls synthesis of the video frames received from the first drawing apparatus 200 and second drawing apparatus 2. In addition, the controller 11 comprises the timing request information generator 10.

The communication unit 102 exchanges an operational instruction and its response with the first drawing apparatus 200 and second drawing apparatus 2.

The first image input unit 141 and second image input unit 142 periodically receive a video frame from the first drawing apparatus 200 and second drawing apparatus 2, respectively.

The first input image analyzer 181 and second input image analyzer 182 analyze the video frames the first image input unit 141 and second image input unit 142 receive, respectively, to detect the timing information.

The image synthesizing unit 105 synthesizes the video frames of the first image input unit 141 and second image input unit 142.

The display output unit 16 outputs the video frame of the image synthesizing unit 105 to a display to be displayed.

The console 17 receives an operation from a user.

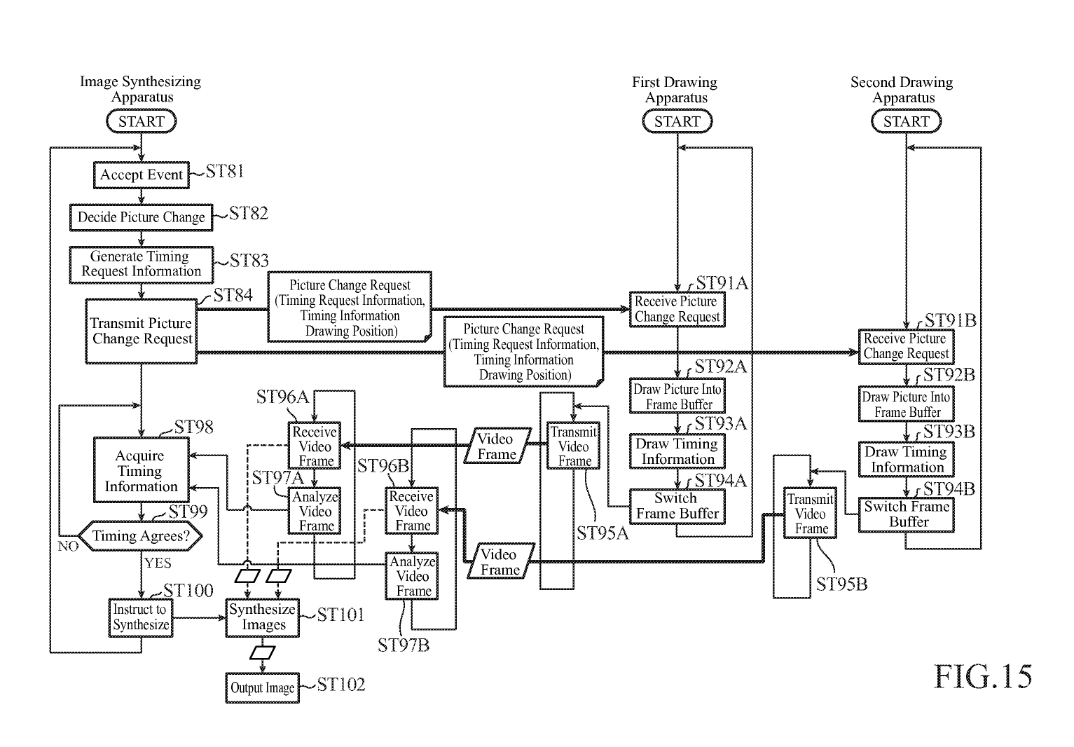

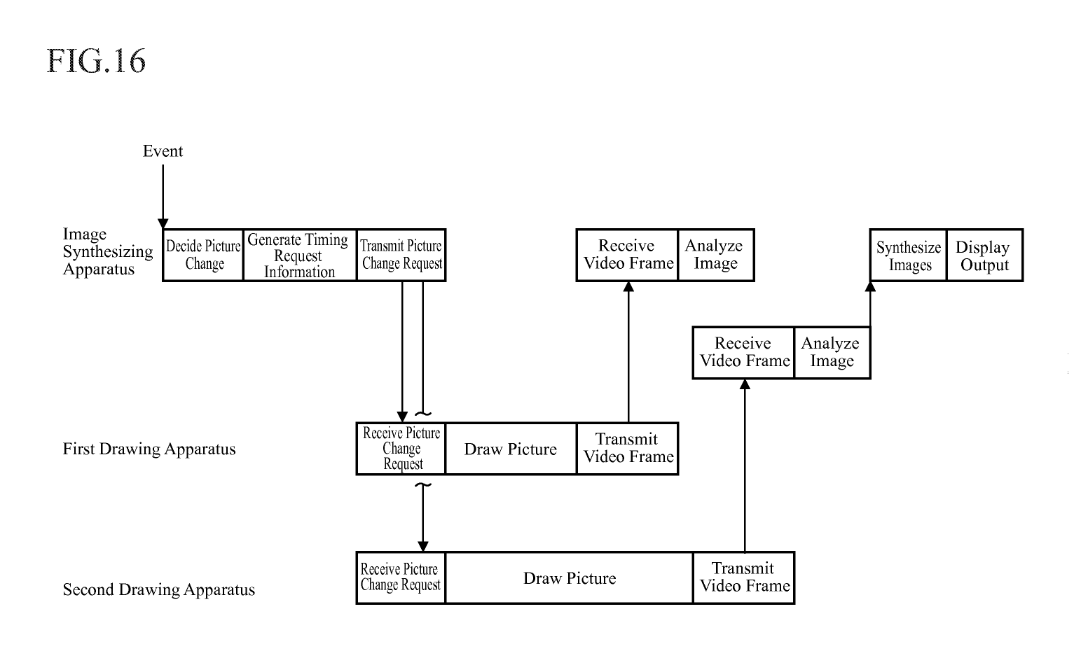

Next, the operation of the present embodiment 4 will be described with reference to FIG. 15 and FIG. 16.

FIG. 15 is a flowchart showing the operation of the image synthesizing apparatus, first drawing apparatus and second drawing apparatus in the embodiment 4.

In addition, FIG. 16 is a timing chart showing the timing of the operation of the image synthesizing apparatus, first drawing apparatus and second drawing apparatus in the embodiment 4.

As for the processing at steps ST81-ST83, since it is the same as the processing at steps ST21-ST23 of FIG. 7 in the embodiment 2, its description will be omitted.

Then, the controller 101 of the image synthesizing apparatus 100 transmits a picture change request to the controller 201 of the first drawing apparatus 200 and the controller 21 of the second drawing apparatus 2 via the communication unit 102 and the communication units 202 and 22, wherein the picture change request contains the timing request information it generates at step ST83 and the timing information drawing position into which the first drawing apparatus 200 and second drawing apparatus 2 draw the timing information on the video frames (step ST84).

After that, the image synthesizing apparatus 100 waits until it receives the video frames with the timing information corresponding to the timing request information from the first drawing apparatus 200 and second drawing apparatus 2 (the details of which will be described later).

The first drawing apparatus 200 and second drawing apparatus 2, receiving the picture change request from the image synthesizing apparatus 100, respectively (steps ST91A and ST91B), the drawing unit 203 and drawing unit 23 draw a picture in a drawing frame buffer (steps ST92A and ST92B).

Furthermore, they draw the timing information into the timing information drawing positions on the drawing frame buffers (steps ST93A and ST93B).

After that, the first drawing apparatus 200 and second drawing apparatus 2 switch the drawing frame buffers to be output by the image output unit 204 and image output unit 24, respectively (steps ST94A and ST94B).

The image output unit 204 and image output unit 24 transmit the video frames periodically from the drawing frame buffers to the first image input unit 141 and second image input unit 142 of the image synthesizing apparatus 100 (steps ST95A and ST95B).

Here, the first image input unit 141 and second image input unit 142 of the image synthesizing apparatus 100 receive the video frames from the image output unit 204 of the first drawing apparatus 200 and from the image output unit 24 of the second drawing apparatus 2, respectively (steps ST96A and ST96B), and store the received video frames in the input frame buffers of the first image input unit 141 and of the second image input unit 142.

Next, the first input image analyzer 181 and second input image analyzer 182 of the image synthesizing apparatus 100 analyze the video frames (graphic images) the first image input unit 141 and second image input unit 142 receive, respectively, and acquire the timing information drawn in the timing information drawing position transmitted via the communication unit 102 (steps ST97A and ST97B).

More specifically, the position in the video frames to be analyzed is the timing information drawing position transmitted from the image synthesizing apparatus 100 to the first drawing apparatus 200 and second drawing apparatus 2. Then, the first input image analyzer 181 and second input image analyzer 182 deliver the timing information acquired by the analysis to the controller 101.

The controller 101 acquires the timing information from the first input image analyzer 181 and second input image analyzer 182 (step ST98), and compares the timing information acquired with the timing request information transmitted to the first drawing apparatus 200 and second drawing apparatus 2 at step ST84 to decide whether they agree with each other (step ST99).

Then, if both the timing information received from the first drawing apparatus 200 and the timing information received from the second drawing apparatus 2 agree with the timing request information, that is, if the two timing information items acquired are both synchronized with the timing of the timing request information (YES at step ST99), the controller 101 instructs the image synthesizing unit 105 to synthesize the graphic images (step ST100). On the other hand, if they disagree, that is, if they are not synchronized in timing (NO at step ST99), it waits until it receives the video frames with the timing information of the same timing as the timing request information.

After that, the image synthesizing unit 105 synthesizes the input frame buffer the first image input unit 141 receives from the first drawing apparatus 200 with the input frame buffer the second image input unit 142 receives from the second drawing apparatus 2 (step ST101). The image synthesized is output to the display by the display output unit 16 to be displayed (step ST102).

As described above, according to the present embodiment 4, the image synthesizing apparatus transmits the picture change request together with the timing request information and the timing information drawing position to the first drawing apparatus and second drawing apparatus; the first drawing apparatus and second drawing apparatus draw the timing information in the video frames to be transmitted to the image synthesizing apparatus; and the image synthesizing apparatus analyzes the timing information and when it decides that it receives the video frames corresponding to the request from the image synthesizing apparatus, it synthesizes the images at the timing. With the configuration, the image synthesizing apparatus can synthesize the graphic images the first drawing apparatus and the second drawing apparatus each draw with their timing being synchronized to be displayed.

In addition, since the method draws the timing information on the video frames to be sent to the image synthesizing apparatus side from the first drawing apparatus and second drawing apparatus, it is characterized by that it does not require any particular component for transmitting the timing information in synchronization with the timing of the video frame transmission.

### Embodiment 5

Although the foregoing embodiments 1-4 are described on the assumption that an image synthesizing apparatus in accordance with the present invention comprises the display output unit (display unit) 16, the image synthesizing apparatus is also applicable to a server of an image synthesizing system or to an application of an image synthesizing system installed in a mobile data terminal such as a smartphone, tablet PC, and mobile phone so as to output to a display device.

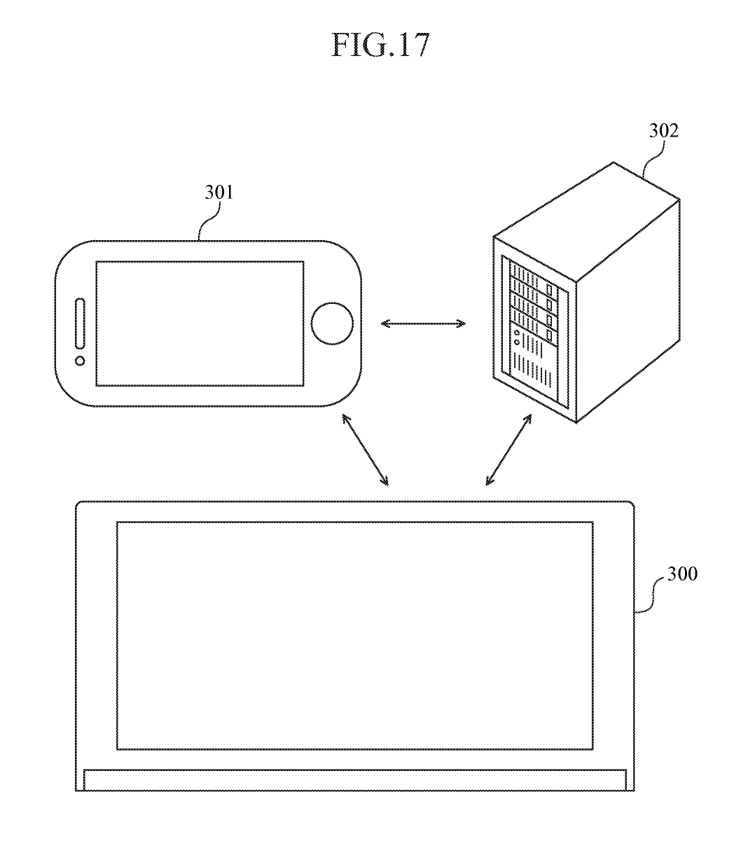

FIG. 17 is a diagram showing an outline of an image synthesizing system of an embodiment 5 in accordance with the present invention 5. The image synthesizing system can take various modes such as those in which a display device 300 with only a display/audio output function performs image synthesis in conjunction with at least one of a mobile data terminal 301 like a smartphone and a server 302, or in which at least one of the mobile data terminal 301 like a smartphone and the server 302 executes the image synthesis and causes the display device 300 to display the synthesized video.

The present embodiment 5 will be described taking an example in which the server 302 executes the image synthesis and causes the display device 300 to display the synthesized image to provide it to a user; and an example in which the mobile data terminal 301 executes the image synthesis in cooperation with the server 302 and causes the display device 300 to display the synthesized image to provide it to a user.

First, the example will be described in which the server 302 executes the image synthesis and causes the display device 300 to display its result.

It is conceivable in this configuration that the display device 300 carries out direct communication with the server 302 or the display device 300 communicates with the server 302 via the mobile data terminal 301. The server 302 functions as the image synthesizing apparatus described in the foregoing embodiments 1-4.

In this case, the display device 300 has only a function of the display output unit (display unit) 16 for providing a user with the image synthesized by the server 302 and a communication function, and receives the image synthesized by the server 302 and provides it to the user.

With such a configuration, the present embodiment 5 can achieve the same advantages as those of the embodiments 1-4.

In addition, the example will be described in which the mobile data terminal 301 carries out the image synthesis in cooperation with the server 302, and the display device 300 provides the user with the synthesized image.

It is conceivable in this configuration that the display device 300 communicates with the server 302 via the mobile data terminal 301, and an application of the mobile data terminal 301 executes the image synthesis in cooperation with the server 302.

In this case also, the display device 300 has only the display function and the communication function basically, and receives the image synthesized by the cooperation of the mobile data terminal 301 and the server 302, and provides it to the user.

More specifically, the display device 300 displays the image synthesized by the application of the mobile data terminal 301, which synthesizes the graphic images drawn by a plurality of drawing apparatuses.

With such a configuration, the present embodiment 5 can achieve the same advantages as those of the embodiments 1-4.

Incidentally, it is to be understood that a free combination of the individual embodiments, variations of any components of the individual embodiments or removal of any components of the individual embodiments is possible within the scope of the present invention.

### INDUSTRIAL APPLICABILITY

An image synthesizing apparatus in accordance with the present invention is applicable even to the case where the graphic images the plurality of apparatuses draw and transmit continuously have a different number of frames, thereby being able to synthesize them while synchronizing them so far as to the timing of changes in an animation, and to cause them to be displayed.

### DESCRIPTION OF REFERENCE SYMBOLS

1 first drawing apparatus (image synthesizing apparatus); 2 second drawing apparatus; 3 timing information; 4 drawn information to be displayed at location where timing information is to be drawn; 10 timing request information generator; 11, 21, 101, 201 controller; 12, 22, 102, 202 communication unit; 13, 23, 203 drawing unit; 14 image input unit; 15, 105 image synthesizing unit; 16 display output unit (display unit); 17 console; 18 input image analyzer; 24, 204 image output unit; 100 image synthesizing apparatus; 141 first image input unit; 142 second image input unit; 181 first input image analyzer; 182 second input image analyzer; 300 display device; 301 mobile data terminal; 302 server.

What is claimed is:

1. An image synthesizing apparatus which synthesizes graphic images a plurality of drawing apparatuses draw to be displayed, the image synthesizing apparatus comprising:
a controller to control operation of the image synthesizing apparatus;
a timing request information generator to generate timing request information for designating timing for synthesizing the graphic images the plurality of drawing apparatuses draw;
a communicator to transmit the timing request information the timing request information generator generates to the plurality of drawing apparatuses;
an image input unit to receive the graphic images the plurality of drawing apparatuses draw and transmit;
an image synthesizer to receive the instruction from the controller and synthesizes the graphic images the image input unit receives; and
a display output unit to cause the graphic image the image synthesizer synthesizes to be displayed, wherein
the controller instructs the image synthesizer to synthesize the graphic images when the timing the timing request information designates comes, which timing request information is transmitted to the plurality of the drawing apparatuses via the communicator.

2. The image synthesizing apparatus according to claim 1, further comprising:
an input image analyzer to analyze the graphic images the image input unit receives from the plurality of drawing apparatuses, and extract timing information indicating timing at which the graphic images have been drawn, wherein
the communicator transmits, together with the timing request information, a timing information drawing position that designates a position, at which the timing information is to be drawn, to the plurality of drawing apparatuses;
the input image analyzer acquires the timing information drawn at the timing information drawing position the communicator transmits from the graphic images the image input unit receives from the plurality of drawing apparatuses; and
the controller instructs the image synthesizer to synthesize the graphic images when the timing information the input image analyzer acquires reaches the timing the timing request information designates.

3. The image synthesizing apparatus according to claim 1, further comprising:
an input image analyzer to analyze the graphic images the image input unit receives from the plurality of drawing apparatuses, and extract timing information indicating timing at which the graphic images have been drawn, wherein
the communicator receives from the plurality of drawing apparatuses a timing information drawing position that designates a position at which the timing information is to be drawn;
the input image analyzer acquires, from the graphic images the image input unit receives from the plurality of drawing apparatuses, the timing information drawn at the timing information drawing position the communicator receives; and
the controller instructs the image synthesizer to synthesize the graphic images when the timing information the input image analyzer acquires reaches the timing the timing request information designates.

4. The image synthesizing apparatus according to claim 1, wherein one of the plurality of drawing apparatuses is included in the image synthesizing apparatus.

5. The image synthesizing apparatus according to claim 1, wherein the timing request information is one of the time, elapsed time from a communication starting time by the communicator, and a video frame number.

6. The image synthesizing apparatus according to claim 2, wherein the timing information drawn in the graphic images is one of a two-dimensional code, a character string, a binary value, and a digital watermark.

7. An image synthesizing apparatus which synthesizes graphic images a plurality of drawing apparatuses draw to be displayed on a display device, the image synthesizing apparatus comprising:
a controller to control operation of the image synthesizing apparatus;
a timing request information generator to generate timing request information for designating timing for synthesizing the graphic images the plurality of drawing apparatuses draw;
a communicator to transmit the timing request information the timing request information generator generates to the plurality of drawing apparatuses;
an image input unit to receive the graphic images the plurality of drawing apparatuses draw and transmit; and
an image synthesizer to receive the instruction from the controller and synthesizes the graphic images the image input unit receives, wherein
the controller instructs the image synthesizer to synthesize the graphic images when the timing the timing request information designates comes, which timing request information is transmitted to the plurality of the drawing apparatuses via the communicator.

8. An image synthesizing method in which an image synthesizing apparatus synthesizes graphic images a plurality of drawing apparatuses draw to be displayed on a display device, the image synthesizing method comprising the steps of:
generating, with a timing request information generator, timing request information for designating timing for synthesizing the graphic images the plurality of drawing apparatuses draw;
transmitting, with a communicator, the timing request information the timing request information generator generates to the plurality of drawing apparatuses;
receiving, with an image input unit, the graphic images the plurality of drawing apparatuses draw and transmit;
synthesizing, with an image synthesizer, the graphic images the image input unit receives when the image synthesizer receives an instruction from a controller that controls operation of the image synthesizing apparatus; and
instructing, with the controller, the image synthesizer to synthesize the graphic images when the timing the timing request information designates comes, which timing request information is transmitted to the plurality of the drawing apparatuses via the communicator.
